(19) United States
(12) Patent Application Publication
(10) Pub. No.: US 2021/0239089 A1
(43) Pub. Date: Aug. 5, 2021

(54) WIND TURBINE ROTOR BLADE

(71) Applicant: Wobben Properties GmbH, Aurich (DE)

(72) Inventors: Florian RUBNER, Aurich (DE); Johannes PRESCHER, Bremen (DE); Sebastian ENGELHARDT, Aurich (DE)

(21) Appl. No.: 17/269,832

(22) PCT Filed: Aug. 20, 2019
(86) PCT No.: PCT/EP2019/072221

§ 371 Date: Feb. 19, 2021

(30) Foreign Application Priority Data
Aug. 21, 2018 (DE) 10 2018 120 264.4

(51) Int. Cl. F03D 1/06; B29C 70/48; B29C 70/78

(52) U.S. Cl. CPC F03D 1/0675; B29C 70/48; B29L 2031/085; F05B 2240/304; F05B 2230/20; B29C 70/78

(57) ABSTRACT

A wind turbine rotor blade having a flatback trailing edge. The flatback trailing edge has at least one insert which has a flat outside and a curved inside.

### BACKGROUND

### Technical Field

The present invention concerns a wind turbine rotor blade and a wind turbine having a corresponding rotor blade.

### Description of the Related Art

Wind turbine rotor blades having a flatback profile are sufficiently known. US 2010/0143146 A1 discloses a rotor blade of a wind turbine having a flatback profile. Provided in the region of the rotor blade trailing edge which represents the flatback profile is an end edge insert in the form of a foam body to improve the stability of the rotor blade. A plurality of fiber layers are provided on the end of the foam body, that faces towards the rotor blade inside. The foam body serves as a reinforcing core.

On the German patent application from which priority is claimed the German Patent and Trade Mark Office searched the following documents: DE 10 2014 203 936 A1, US 2010/0 143 146 A1, EP 3 018 342 B1, EP 3 085 952 A1 and WO 2018/015 250 A1.

### BRIEF SUMMARY

Provided is a wind turbine rotor blade with a flatback profile, which can be more efficiently produced.

Thus there is provided a wind turbine rotor blade having a flatback trailing edge. The flatback trailing edge has at least one insert which has a flat outside and a curved inside. The insert can constitute a part of the trailing edge (for example as an end edge insert). The flat outside of the insert can thus form the flat trailing edge of the flatback profile.

According to an aspect of the present invention the curved inside of the insert is of such a configuration that laying or application of a fiber mat in the correct fiber relationship is made possible.

According to a further aspect of the invention subsequently the outer laminate, a preform, optionally the core material and the inner laminate are placed on the insert during production. It is optionally possible to dispense with a core material in particular in the region near the flange.

Provided is a method of producing a wind turbine rotor blade. At least one insert is placed in a mold for the production of the wind turbine rotor blade. The insert has a flat outside and a curved inside. A preform or an outer laminate is placed on the curved inside of the insert. Core material and inner laminate can be placed on the preform or the outer laminate. Then a vacuum infusion method can optionally be carried out for the production of a half shell for the wind turbine rotor blade.

Embodiments concern the concept of providing the aerodynamically important configuration of the flatback profile with an end edge insert, for example in the form of a foam body. The flatback trailing edge is therefore not constituted or provided by fiber composite but by an (end edge) insert.

To permit production of a rotor blade with the correct fiber relationship geometries with a right angle are avoided at the inside of the insert. Therefore minimum radii of curvature are observed in the geometry of the rotor blade to optimize the load flow in those regions. Particularly in the production of a wind turbine rotor blade having a flatback profile (which typically has a right angle in the region of the trailing edges) it is otherwise extremely difficult for the fiber mat to be applied into the corners with the right angles. That can lead to structural deterioration of the rotor blade. The stiffness levels could admittedly remain substantially the same but the strength levels can be seriously impaired.

With the wind turbine rotor blade according to one or more embodiments of the invention fabrics or mats can be produced in the optimum fiber fashion in the region of the end edge/flatback or can be applied with the correct fiber relationship.

It is thus in addition possible to avoid a pure resin accumulation. A sharp trailing edge can be achieved by the provision of the foam insert in the region of the trailing edge so that it is possible to implement the shape which is aerodynamically required without it having negative effects.

In particular it is possible to achieve a clean flow breakoff edge for the flow by means of the foam insert or an end edge insert.

In that way it is possible to provide a wind turbine rotor blade having a flatback profile without further attachment parts being required.

The inserts, for example an end edge insert, are already integrated in production of the rotor blade. As an alternative thereto the inserts can also be subsequently fitted if the radii of curvature of the end edge are also present in the mold.

The wind turbine rotor blade makes it possible to optimize a force flow within the fiber mat (as a construction which has the fibers in the correct relationship is implemented). In addition the desired aerodynamic contour can be retained. Furthermore it is possible to comply with the original geometry of the rotor blade as no further attachment parts are needed.

According to an aspect of the present invention the foam inserts are already introduced into the main mold in the production of the rotor blade.

It is possible in that way to dispense with a further step in manufacture of the rotor blade.

Further configurations of the invention are subject-matter of the appendant claims.

### BRIEF DESCRIPTION OF THE SEVERAL VIEWS OF THE DRAWINGS

Advantages and embodiments by way of example of the invention are described in greater detail hereinafter with reference to the drawing.

FIG. 1 shows a diagrammatic view of a wind turbine according to the invention,

FIG. 2 shows a diagrammatic view in section of a wind turbine rotor blade according to an aspect of the present invention,

FIG. 3 shows a diagrammatic view in section of a wind turbine rotor blade according to a first embodiment,

FIG. 4 shows a diagrammatic view in section of a part of a wind turbine rotor blade according to an embodiment,

FIG. 5 shows a diagrammatic view in section of a wind turbine rotor blade according to an embodiment in production of the rotor blade, and

FIG. 6 shows a perspective view in section of foam inserts or a wind turbine rotor blade according to an aspect of the present invention.

### DETAILED DESCRIPTION

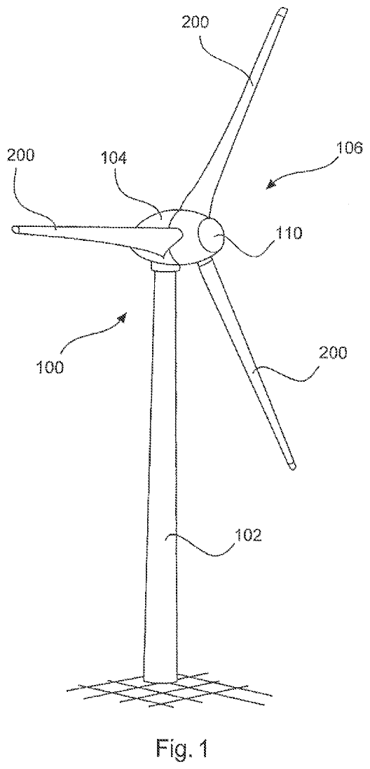

FIG. 1 shows a diagrammatic view of a wind turbine. FIG. 1 shows a wind turbine 100 comprising a tower 102 and a nacelle 104. Arranged on the nacelle 104 is a rotor 106 having three rotor blades 200 and a spinner 110. In operation the rotor 106 is caused to rotate by the wind and thereby drives a generator in the nacelle 104.

The wind turbine rotor blade 200 is typically formed by two half shells, wherein one half shell represents the pressure side and the other half shell represents the suction side. The wind turbine rotor blade also has a flatback profile, that is to say the rotor blade trailing edge is at least partially straight.

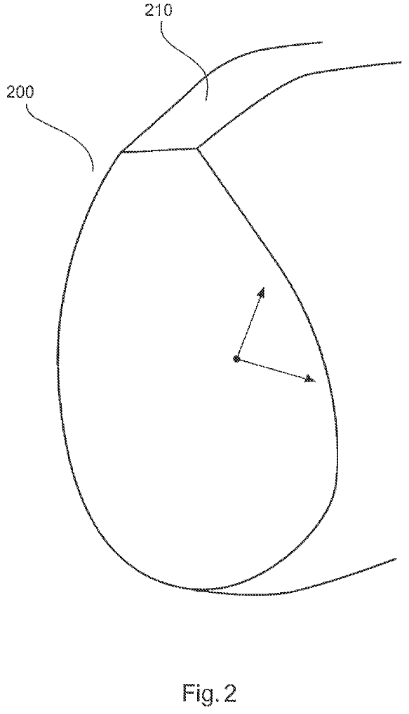

FIG. 2 shows a diagrammatic view in section of a wind turbine rotor blade according to an aspect of the present invention. In this case the rotor blade 200 has a flatback profile 210, that is to say a flattened trailing edge.

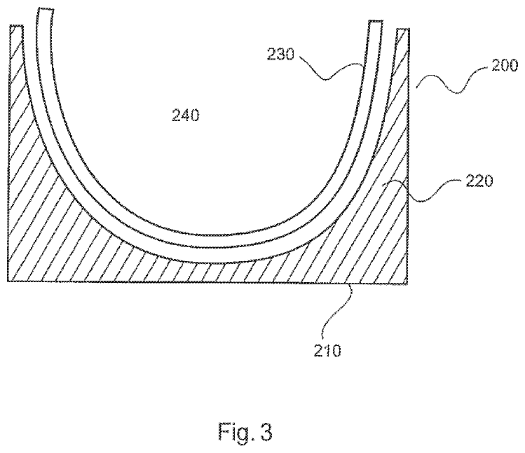

FIG. 3 shows a diagrammatic view in section of a wind turbine rotor blade according to a first embodiment. FIG. 3 shows in particular the end edge or the flatback 210 of the rotor blade. In FIG. 3 the insert is shown as extending circumferentially. However by virtue of the production method the insert can also be of a divided configuration. FIG. 3 further shows an insert 220 (for example an end edge insert), a laminate layer 230 and a preform 240. As an alternative to a preform it is also possible to introduce fixed parts (infused and tempered).

The insert 220 can be made from different materials like for example balsa wood, PET (Polyethylene Terephthalate), PVC (polyvinyl chloride) or PU (polyurethane) foam.

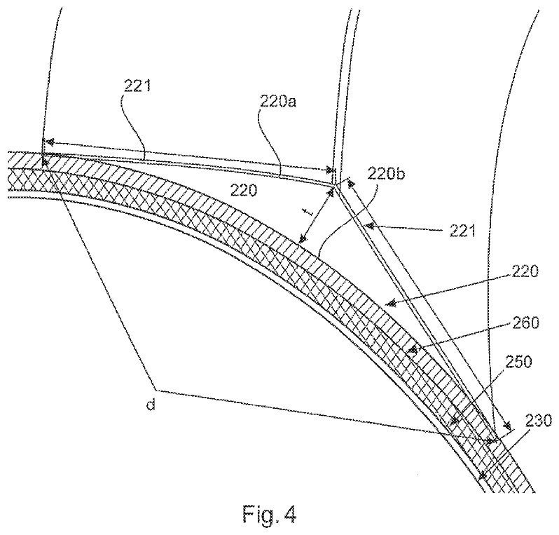

FIG. 4 shows a diagrammatic view in section of a part of a wind turbine rotor blade according to a further embodiment. Cover layers 221 can be provided over the insert 220 or on the insert. The inside 220b of the insert 220 is of a curved configuration. The outer laminate can follow the insert. The preform 260 can then be placed. That can be followed by the core material 250 and then the inner laminate 230 can be applied.

The inserts 220 are typically prefabricated and at their first side 220a have a flat end which then determines or shapes or constitutes the flatback profile of the rotor blade 200. At its second side 220b the foam inserts 220 have a curved profile which is of such a configuration that the fiber mats (fiber fabric or weave) can be fitted in with the fibers substantially in the correct relationship. The foams used can represent for example PET foams. The foam inserts 220 can be milled to the correct shape. As an alternative thereto it is also possible to carry out alternative production methods like for example a foamed geometry or a layer-wise structure.

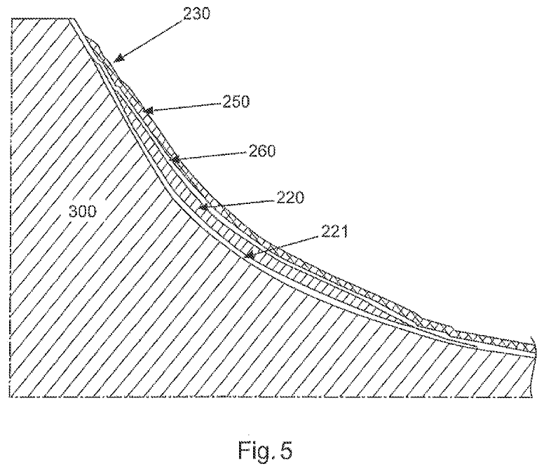

FIG. 5 shows a diagrammatic view in section of a wind turbine rotor blade according to an aspect in production of the rotor blade. To produce the rotor blade 200 the foam inserts 220 are placed in a mold 300, then optionally an outer laminate, a preform 260, core material 250 and an inner laminate 230 can be placed. A half-shell is then produced for example by means of the vacuum assisted transfer molding (VATM) method.

That is advantageous because tolerances or inaccuracies in the inserts 220 can be compensated therewith. Optional cover layers 221 can be provided over the inserts 220 in production of the rotor blade, which cover layers can then represent the outer surface of the rotor blade 200 at least in the region of the flatback 210.

The inserts are incorporated during the normal process of producing the rotor blade so that no additional separate parts have to be subsequently fitted.

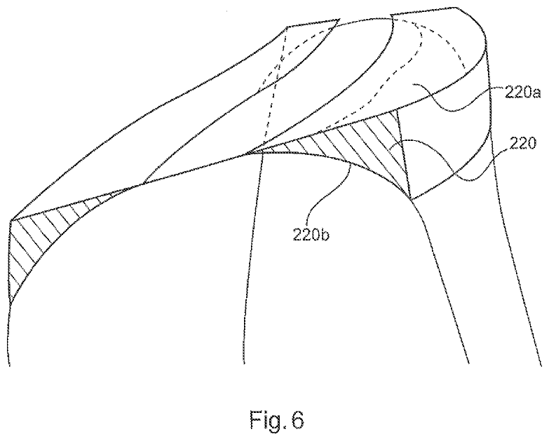

FIG. 6 shows a perspective view in section of the insert 220 for a wind turbine rotor blade according to an aspect. The inserts 220 have an outside 220a and an inside 220b. The outside 220a is preferably smooth or flat while the inside is of a curved configuration in order in that way to permit laying of the fiber mats in the correct fiber orientation.

1. A wind turbine rotor blade, comprising:
a flatback trailing edge, wherein the flatback trailing edge has at least one insert having a flat outside surface and a curved inside surface;
a preform or an outer laminate placed at an inside of the insert; and
a core material and an inner laminate on the preform or the outer laminate.

2. The wind turbine rotor blade according to claim 1 comprising a body portion, wherein the curved inside surface of the at least one insert corresponds to a curvature of the body portion.

3. The wind turbine rotor blade according to claim 1 wherein the at least one insert is a foam insert, an insert of balsa wood, or an insert of PET, PVC or PU.

4. (canceled)

5. A wind turbine comprising at least one wind turbine rotor blade according to claim 1.

6. A method comprising:
producing a half-shell of a wind turbine rotor blade having a flatback profile, wherein producing comprises:
placing at least one insert in a mold for the production of the half-shell of the wind turbine rotor blade, wherein the at least one insert has a flat outside surface and a curved inside, surface;
placing a preform or an outer laminate on the curved inside surface of the at least one insert;
placing core material and inner laminate on the preform or the outer laminate; and
carrying out a vacuum infusion method to thereby produce the half-shell for the wind turbine rotor blade.

7. The wind turbine rotor blade according to claim 2 wherein the body portion is a half shell.

8. The wind turbine rotor blade according to claim 1 wherein the at least one insert is a plurality of inserts.
